(19) United States
(12) Patent Application Publication
(10) Pub. No.: US 2006/0068247 A1
(43) Pub. Date: Mar. 30, 2006

(54) Fuel reforming system and fuel cell system therewith

(75) Inventors: Masahiro Kuwata, Kawasaki-shi (JP); Yoshiyuki Isozaki, Edogawa-ku (JP); Fuminobu Tezuka, Yokohama-shi (JP); Yuusuke Sato, Bunkyo-ku (JP); Hideo Kitamura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/231,972

(22) Filed: Sep. 22, 2005

(30) Foreign Application Priority Data
Sep. 30, 2004 (JP) 2004-288743

(51) Int. Cl. H01M 8/06; B01J 19/00

(52) U.S. Cl. 429/20; 422/198

(57) ABSTRACT

A fuel cell system is provided with: a container having a double wall and an opening at an end of the double wall, the double wall including an inner wall, an outer wall and a sealed space defined by the inner wall and the outer wall, the sealed space being evacuated; a fuel supplier supplying a fuel including an organic compound; a reformer reforming the fuel into a reformed gas including hydrogen, the reformer being enclosed in the container; a fuel supply path linking the fuel supplier to the reformer; a heat absorber being in contact with the inner wall and disposed between the reformer and the opening; and a fuel cell receiving and using the reformed gas to generate electricity.

### CROSS-REFERENCE TO RELATED APPLICATIONS

This application is based upon and claims the benefit of priority from the prior Japanese Patent Application No. 2004-288743 (filed Sep. 30, 2004); the entire contents of which are incorporated herein by reference.

### BACKGROUND OF THE INVENTION

1. Field of the Invention

The present invention in general relates to a fuel reforming system and a fuel cell system therewith preferably applied to portable electric equipments such as a note-type PC, a digital camera and a video camera, and more particularly relates to a fuel reforming system and a fuel cell system therewith controlling heat transmission from a reformer housed therein to the exterior.

2. Description of the Related Art

Applications of fuel cells to power sources of portable electronic equipments are under eager study in these years. Direct-type fuel cells directly, namely without any treatment, use fuel to generate electricity, however, the other fuel cells are in general provided with reforming means for bringing about a reforming reaction to extract hydrogen from the fuel and use the extracted hydrogen.

The reforming means is in general accompanied by some auxiliary components such as a heater and/or a supplementary reactor. The auxiliary components considerably generate heat though the reforming reaction is per seendothermic. Therefore the reforming system as a whole generates considerable amount of heat.

In a case of practical use, a fuel cell is installed in a limited space of an electronic equipment. Certain parts surrounding the fuel cell may be sensitive to heat and operators of the electronic equipments may need comfortable work environment. Therefore, in view of practical use of the fuel cells, not only down-sizing but also heat control are of considerable technical importance.

### SUMMARY OF THE INVENTION

According to a first aspect of the present invention, a fuel reforming system is provided with: a container having a double wall and an opening at an end of the double wall, the double wall including an inner wall, an outer wall and a sealed space defined by the inner wall and the outer wall, the sealed space being evacuated; a fuel supplier supplying a fuel including an organic compound; a reformer reforming the fuel into a reformed gas including hydrogen, the reformer being enclosed in the container; a fuel supply path linking the fuel supplier to the reformer; and a heat absorber being in contact with the inner wall and disposed between the reformer and the opening.

According to a second aspect of the present invention, a fuel reforming system is provided with: a fuel supplier supplying a fuel including an organic compound; a reformer reforming the fuel into a reformed gas including hydrogen; a fuel supply path linking the fuel supplier to the reformer; and a container to enclose the reformer, the container having a double wall and an opening at an end of the double wall, the double wall including an inner wall, an outer wall and an evacuated space sealed by the inner wall and the outer wall, wherein at least a part of the fuel supply path is in contact with the inner wall of the container so as to bring about heat absorption from the inner wall to the fuel supply path.

According to a third aspect of the present invention, a fuel cell system is provided with: a fuel supplier supplying a fuel including an organic compound; a reformer reforming the fuel into a reformed gas including hydrogen; a fuel supply path linking the fuel supplier to the reformer; a container to enclose the reformer, the container having a double wall and an opening at an end of the double wall, the double wall including an inner wall, an outer wall and an evacuated space sealed by the inner wall and the outer wall, wherein at least a part of the fuel supply path is in contact with the inner wall of the container so as to bring about heat absorption from the inner wall to the fuel supply path; and a fuel cell receiving and using the reformed gas to generate electricity.

### BRIEF DESCRIPTION OF THE DRAWINGS

FIG. 1A is an illustration of a fuel reforming system according to a first embodiment of the present invention;

FIGS. 1B and 1C illustrate heat balance of the fuel cell reforming system;

FIGS. 2A and 2B are illustrations of a fuel reforming system according to a second embodiment of the present invention;

FIGS. 3A and 3B are illustrations of a fuel reforming system according to a third embodiment of the present invention;

FIGS. 4A and 4B are illustrations of a fuel reforming system according to a fourth embodiment of the present invention;

FIG. 5 is an illustration of a fuel reforming system according to a fifth embodiment of the present invention;

FIG. 6 is an illustration of a fuel reforming system according to a sixth embodiment of the present invention;

FIG. 7 is an illustration of a fuel reforming system according to a seventh embodiment of the present invention; and

FIG. 8 is an illustration of a fuel cell system in accordance with a version of the present invention.

### DETAILED DESCRIPTION OF THE INVENTION

Certain embodiments of the present invention will be described hereinafter with reference to accompanying drawings.

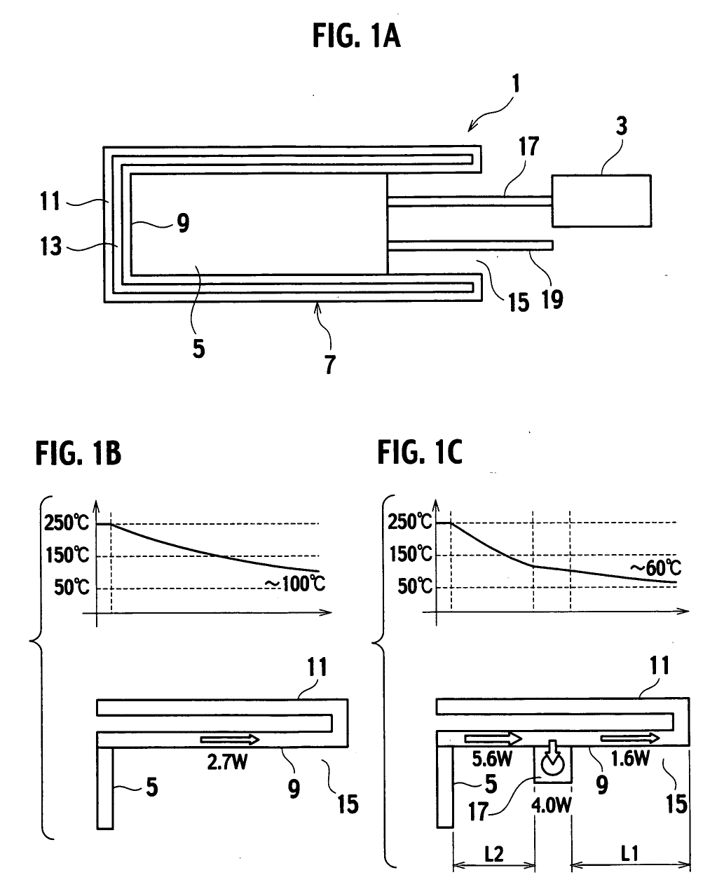

Reference is now made to FIG. 1A. A fuel reforming system 1 is provided with a fuel supplier (a fuel tank) 3 housing fuel of any organic compound such as methanol or dimethyl ether, a reformer 5 for reforming the fuel into a reformed gas including hydrogen, and a container 7 enclosing the reformer 5. The container 7 is a double-walled vessel, similar to a so-called Dewar vessel, composed of an inner wall 9 and an outer wall 11, by which a sealed space 13 is defined and sealed. The sealed space 13 is evacuated to be a vacuum so that the container 5 is thermally insulating. The container 5 has an opening 15 at an end thereof.

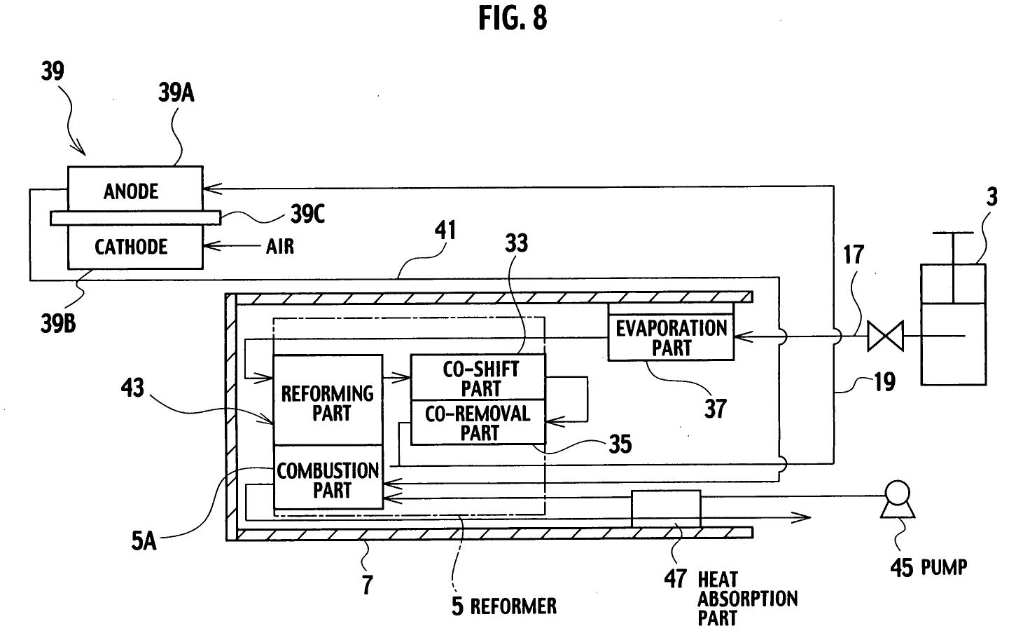

A fuel supply path 17 links the fuel supplier 3 to the reformer 5 and the fuel is supplied to the reformer 5 therethrough. The reformer 5 brings about a reforming reaction of organic components of the fuel by using high temperatures up to several hundreds degrees C. so as to form the reformed gas containing the hydrogen. A combustion part (not shown in FIG. 1A but referred as 5A in FIG. 8) is provided for filling a thermal energy required by the reforming reaction. The reformer 5 is disposed apart from, namely recedes from, the opening 15 so as to suppress heat transmission out of the container 7, thereby thermal energy loss of the reformer 5 and heat influence on exterior parts are suppressed. Though the reformer 5 is schematically drawn as a rectangular part separated from the other parts in FIG. 1A, a CO-shifting part, a CO-removal part and the combustion part may be provided as in a integrated body with the reformer 5 or in individually separated bodies. Needless to say, component elements of the reformer 5 are not limited by the above description and may include any additional elements or some of the elements may be omitted or replaced by any other elements. For example, the combustion part may be replaced by an electric heater, or the CO-shifting part may be omitted.

A discharge path 19 links the reformer 5 to a fuel cell (not shown in FIG. 1A but referred as 39 in FIG. 8) so that the reformed gas is discharged and supplied to the fuel cell.

Though the reformer 5 is heated up to several hundreds degrees C. so as to bring about the reforming reaction, the disposition of the reformer 5 receded from the opening 15 preserves the opening 15 and its peripheries in relatively low temperatures. However, the heat of the reformer 5 tends to be transferred via the inner wall 9 to the outer wall 11 because the inner wall 9 and the outer wall 11 are connected with each other at the end of the opening 15.

Therefore the heat transmission via the inner wall 9 and the outer wall 11 may not be ignored if the reformer 5 gets a high temperature. This leads to an increase in the heat influence on the exterior parts and a reduction in thermal efficiency of the reforming system 1. FIG. 1B illustrates a heat balance. As being understood from this illustration, a temperature around the opening 15 of the container 7 comes to be about 100 degrees C. given that a temperature of a contact area of the inner wall 9 with the reformer 5 is about 250 degrees C.

In contrast, in accordance with the present embodiment, the fuel supply path 17 is partly in contact with the inner wall 9 of the container 7 so as to bring about,heat absorption from the inner wall 9 through the fuel supply path 17 to the fuel. The heat absorption causes heating of the fuel flowing through the fuel supply path 17 and reduction in the heat transmission via the inner wall 9 to the outer wall 11 as illustrated in FIG. 1C. Hence a temperature of the container 7 around the opening 15 is reduced to about 60 degrees C., which is lower than the case without thermal contact between the fuel supply path 17 and the inner wall 9 shown in FIG. 1B.

The heat absorbed by the fuel flowing through the fuel supply path 17 is used for evaporating the fuel at least in part, namely evaporable components (for example, methanol, dimethyl ether or water) contained in the fuel. More specifically, the contact portion of the fuel supply path 17 with the inner wall 9 functions as an evaporation portion for evaporating the fuel (a heat absorber where the fuel absorbs the heat). The evaporation portion should be appropriately disposed so that the temperature of the fuel can reach a boiling point of any evaporable component contained therein. Then the heat of vaporization is used to suppress the temperature increase of the outer wall 11.

Any structure advantageous to evaporation of the fuel, such as a reticular structure, a nonwoven structure, a wick structure, a mixer structure or a channel structure, may be preferably applied to the evaporation portion.

Existence of the evaporation portion leads to an increase in a temperature gradient between the reformer 5 and the evaporation portion and hence causes an increase in a thermal energy transfer from the reformer 5. However, the evaporation of the fuel effectively absorbs the heat at the evaporation portion so as to reduce the temperature of the container 7 around the opening 15.

A position of the evaporation portion is preferably set so that a ratio of L1/ (L1+L2) is 20% or more, where L1 is a distance from the opening 15 to a side of the evaporation portion near the opening 15 and L2 is a distance from an opposite side of the evaporation portion to a side of the reformer 5 near the opening 15 as shown in FIG. 1C. In a case where the ratio is below 20%, the evaporation portion is disposed near the opening 15, namely at a relatively low-temperature portion of the inner wall 9, and hence the effect of the heat absorption is reduced.

Moreover the evaporation portion is preferably prevented from direct contact with the reformer 5. Since the direct contact causes direct heat conduction from the reformer 5 to the evaporation portion and hence may lead to a reduction in the temperature of the reformer 5. Another reason is that the direct contact suppresses the heat absorption from the inner wall to the evaporation portion and hence the heat transmission to the outer wall 11 is increased.

In a case where methanol is applied to the fuel, a stoichiometric ratio of [CH₃OH]:[H₂O] in view of the reforming reaction is 1:1, where the reforming reaction is represented by:
CH₃OH+H₂O→3H₂+CO₂ (1)

However, the stoichiometric ratio causes an increase in a selectivity coefficient of a by-product, namely carbon monoxide, with respect to the reforming reaction and hence a generation ratio of the carbon monoxide is increased. Therefore, water is preferably excessively supplied. A ratio of [CH₃OH]:[H₂O] is preferably set to be about 1:2 or more preferably about 1:1.5.

A calculation will be made on a basis of a case where the ratio of [CH₃OH]:[H₂O] is 1:1.5. A 20W power generation for example requires 250 cc/min of hydrogen, converted as an ideal gas at 0 degrees C. and 1 atm. Therefore required flow rates of CH₃OH and H₂O are respectively 83.33 cc/min and 125 cc/min, converted as ideal gases at 0 degrees C. and 1 atm. Provided that CH₃OH and H₂O at a state that the atmospheric temperature is 25 degrees C. are evaporated and heated to 150 degrees C., which is an example of a temperature of the evaporation portion, required heats are 2.86 W with respect to CH₃OH and 4.48 W with respect to H₂O. A required heat in total is 7.34 W.

Meanwhile, in a case where dimethyl ether is applied to the fuel, a stoichiometric ratio of [CH₃OCH₃]:[H₂O] is 1:3, where the reforming reaction is represented by:
CH₃OCH₃+3H₂O→6H₂+2CO₂ (2)

However, the stoichiometric ratio causes an increase a generation ratio of the carbon monoxide. Therefore, water is preferably excessively supplied. A ratio of[CH₃OCH₃]:[H₂O] is preferably set to be about 1:3.5.

A calculation will be made on a basis of a case where the ratio of [CH₃OCH₃]:[H₂O] is 1:3.5. A 20 W power generation for example requires 250 cc/min of hydrogen, converted as an ideal gas at 0 degrees C. and 1 atm. Therefore required flow rates of CH₃OCH₃ and H₂O are respectively 41.67 cc/min and 145.83 cc/min, converted as ideal gases at 0 degrees C. and 1 atm. Because CH₃OCH₃ is in a gaseous state at room temperature, CH₃OCH₃ is considered to be already in the gaseous state when flowing into the evaporation portion. Therefore, a required heat for heating CH₃OCH₃ at 25 degrees C. to 150 degrees C. is 0.36 W. One for H₂O is 5.22 W. Therefore, a required heat in total is 5.58 W.

More specifically, it can be noted that the required heat for evaporating and heating of fuel with respect to methanol reforming is about 1.3 times greater than one with respect to dimethyl ether reforming.

The above calculations teach that methanol uses greater heat for vaporization and hence causes a reduction in a temperature of the evaporation portion, which may give rise to incomplete evaporation at the evaporation portion. Moreover, the greater heat requirement may cause the heat balance of the fuel reforming system to be a negative. If so, the fuel reforming system may come to be inoperable unless thermal energy added from the exterior compensates for the negative.

In contrast, provided that the required heat is too small, the temperature of the outer wall 11 of the container 7 may be increased.

On the foregoing reasons, the fuel reforming system 1 is preferably applied to reforming of any fuel requiring a moderate heat quantity for vaporization, such as dimethyl ether, though the fuel reforming system 1 of course can be applied to the other fuels.

As being understood from the above description, the fuel reforming system 1 in accordance with the present embodiment suppresses the heat transmission from the reformer 5 to the opening 15 of the container 7 to suppress temperature increase of the outer wall 11 of the container 7. Moreover, the fuel reforming system 1 has relatively high heat efficiency since thermal energy transferred through the inner wall 9 from the reformer 5 to the opening 15 is used for a heat source for evaporation of the fuel.

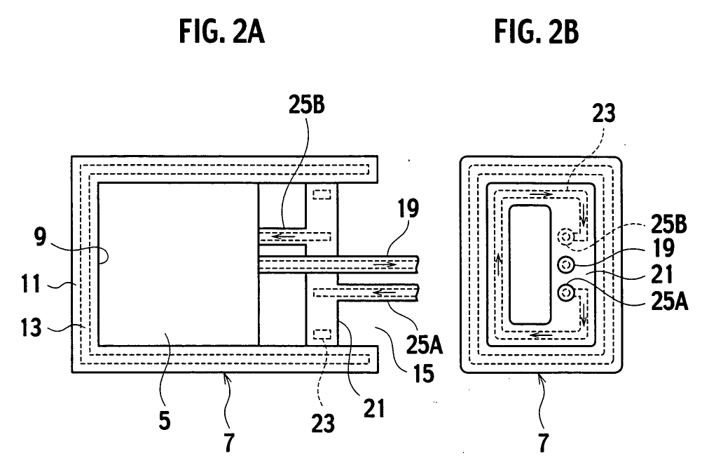

A second embodiment of the present invention will be described hereinafter with reference to FIGS. 2A and 2B. In the following description, substantially the same elements as any of the aforementioned elements are referenced with the same numerals and the detailed descriptions are omitted.

The fuel reforming system 1 of the present embodiment is provided with a plate 21 (a heat absorber) as an evaporation portion for evaporating the fuel, which is in thermal contact with the inner wall 9 of the container 7. Here and throughout the specification and claims, the term “thermal contact” is defined and used as contact configured to bring about heat transmission to sufficient degree and “thermal contact” includes not only close and direct contact but also indirect contact intervening any thermally conductive substance such as copper or heat conductive grease.

The plate 21 has a flow path 23 formed therein, which substantially forms a circle along an outer periphery thereof. One end of the flow path 23 is linked with a fuel supply path 25A which is linked with the fuel supplier 3 and another end is linked with a fuel supply path 25B which is linked with the reformer 5.

The heat being transferred through the inner wall 9 toward the opening 15 is in part absorbed by the plate 21 and used for evaporating the fuel flowing through the flow path 23. Heat transmission toward the opening 15 is instead suppressed, thereby a similar effect as the above first embodiment can be obtained.

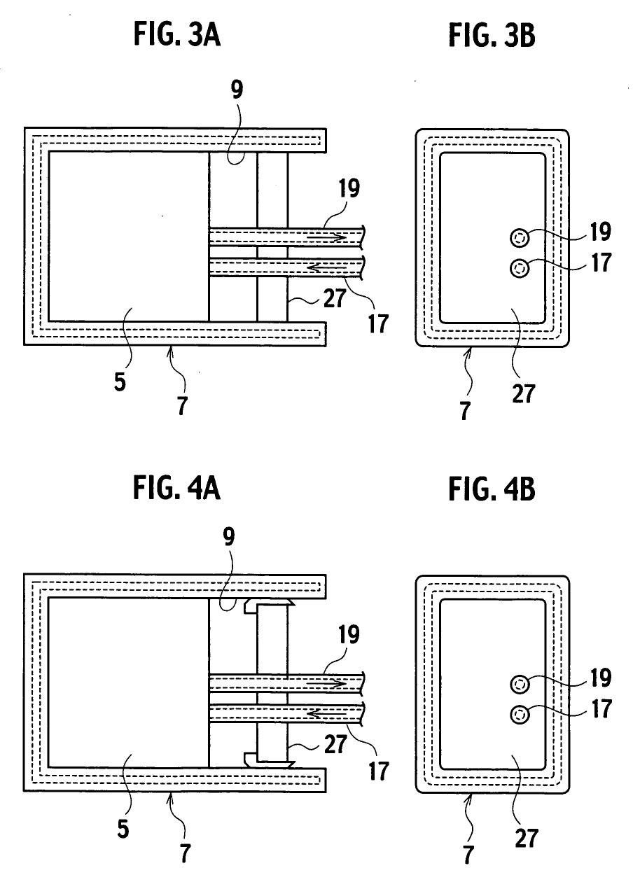

FIGS. 3A and 3B illustrate a third embodiment of the present invention. In the following description, substantially the same elements as any of the aforementioned elements are referenced with the same numerals and the detailed descriptions are omitted.

The fuel reforming system 1 of the present embodiment is provided with a lid-like member 27 (a heat absorber) made of any heat conductive material such as aluminum, peripheral surfaces of which are in thermal contact with the inner wall 9 of the container 7. The fuel supply path 17 and a discharge path 19 penetrate and are supported by the lid-like member 27.

The heat being transferred through the inner wall 9 toward the opening 15 is in part absorbed by the lid-like member 27 and used for evaporating the fuel flowing through the fuel supply path 17. Thereby a similar effect as the above first and second embodiments can be obtained.

FIGS. 4A and 4B illustrate a fourth embodiment of the present invention. In the following description, substantially the same elements as any of the aforementioned elements are referenced with the same numerals and the detailed descriptions are omitted.

A difference of the present fourth embodiment from the above third embodiment is in that the fuel reforming system 1 is further provided with a filler made of any relatively soft and heat conductive metal such as copper interposed between the outer peripheries of the lid-like member 27 and the inner wall 9 of the container 7 so as to fill any clearances therebetween. As an alternative to the metal, any heat conductive grease (for example, a grease including fillers such as silica or alumina) can be applied. The filler reduces contact thermal resistance caused by the clearances and hence effectively increases heat transmission from the inner wall 9 to the lid-like member 27.

Alternatively, the inner wall 9 and the lid-like member 27 may be directly joined by welding, brazing or adhering or any joint structure may be applied to them, for further increasing heat transmission from the inner wall 9 to the lid-like member 27.

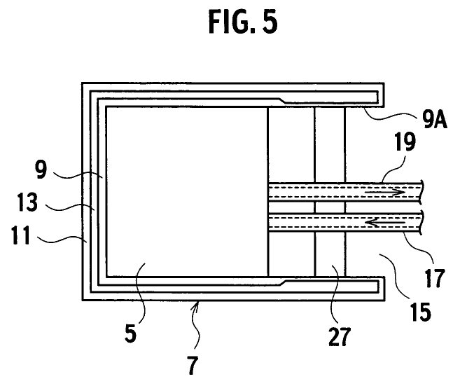

FIG. 5 illustrates a fifth embodiment of the present invention. In the following description, substantially the same elements as any of the aforementioned elements are referenced with the same numerals and the detailed descriptions are omitted.

The inner wall 9 is provided with thin portions 9A where the inner wall 9 is made thinner. The outer peripheries of the lid-like member 27 are joined with the thin portions 9A into a unitary body by welding, brazing or bonding, thereby the thin portions 9A are reinforced.

The thin portions 9A reduce heat transmission therethrough. Thereby a similar effect as the above first through fourth embodiment scan be obtained. Moreover, the thin portions 9A are prevented from deformation caused by a vacuum in the space 13.

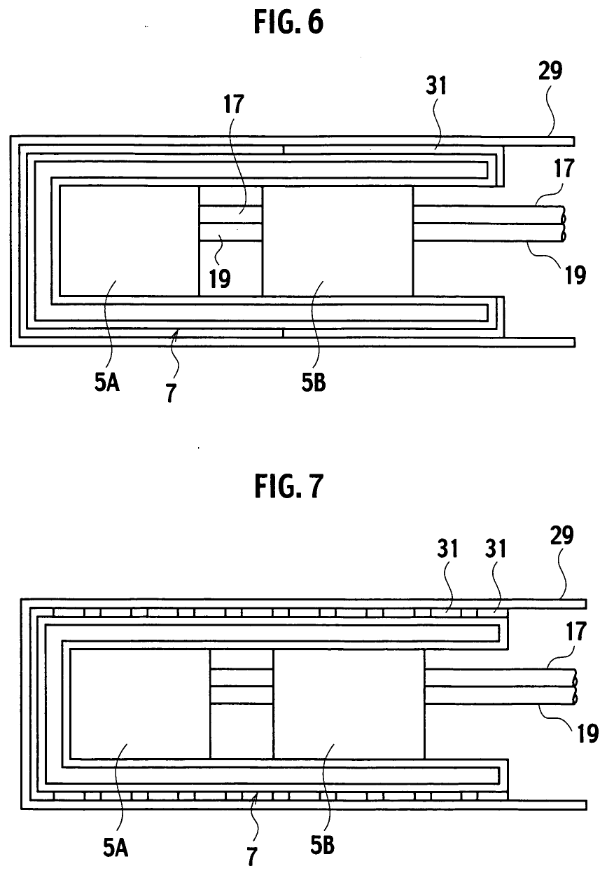

FIGS. 6 and 7 respectively illustrate sixth and seventh embodiments of the present invention. In the following description, substantially the same elements as any of the aforementioned elements are referenced with the same numerals and the detailed descriptions are omitted.

The container 7 encloses a plurality of reformers 5A and 5B and is housed in a chassis 29 of a portable electric equipment to which the reforming system is applied. A heat insulator 31 is interposed between the container 7 and the chassis 29. The heat insulator 31 functions as an absorber for impact applied from the exterior as well as a heat insulator for suppressing heat transmission from the container 7 to the chassis 29. The heat insulator 31 is preferably made of any material, for example a resin, which is appropriate for bringing about the functions. Moreover, the heat insulator 31 preferably includes microscopic pores or micro openings therein for improvement of heat insulation and impact absorption.

Though the heat insulator 31 may enclose the whole outer peripheries of the container 7, alternatively, the heat insulator 31 may partly cover the outer peripheries of the container 7 as shown in FIG. 7, where the heat insulator 31 is separated into plural pieces which lie scattered, streaked or striped at certain intervals around the container 7.

Heat transmission from the container 7 to the chassis 29 can be suppressed by the heat insulator 31. Any heat absorber in accordance with any of the above first through fifth embodiments may also be applied to the fuel reforming system 1 of the present sixth or seventh embodiment, though a heat absorber is not shown in FIGS. 6 and 7.

FIG. 8 illustrates a fuel cell system in accordance with a version of the present invention, which includes a fuel reforming system.

The fuel cell system is provided with a reformer 5 housed in a container 7 and a fuel cell 39 at the exterior of the container 7. The reformer 5 includes a reforming part 43, a CO-shifting part 33, a CO-removal part 35 and an evaporation part 37 (a heat absorber) . The fuel cell 39 is provided with a fuel cell 39 having an anode 39A, a cathode 39B and a polymer electrolyte membrane 39C put therebetween. The discharge path 19 links the reforming part 43 via the CO-shifting part 33 and the CO-removal part 35 to the anode 39A. A connection flow path 41 links an exhaust port of the anode 39A to the combustion part 5A so as to conduct an exhaust gas of the fuel cell 39 to the combustion part 5A.

Fuel supplied from a fuel supplier 3 flows through the evaporation part 37 and is at least in part evaporated there similarly to the aforementioned evaporation portions.

The evaporated fuel flowing into the reforming part 43 is subject to a reforming reaction represented by the aforementioned equation (1) or (2), where (1) is applied to a case where the fuel is methanol and (2) for dimethyl ether, and reformed into a reformed gas containing hydrogen. The reforming part 43 is provided with internal passages therein for transferring the evaporated fuel and a reforming catalyst, which promotes the reforming reaction, is supported on inner surfaces of the internal passages so as to be exposed to the fuel flowing therethrough.

A temperature of the reforming part 43 is preferably controlled to be from 200 to 300 degrees C. for effectively bringing about the reforming reaction represented by the equation (1). A temperature from 220 to 250 degrees C. is more preferable. In a case where dimethyl ether is applied to the fuel, a temperature from 300 to 400 degrees C. is preferable. A temperature from 320 to 380 degrees C. is more preferable.

The reforming reaction may generate from 1 to 5% carbon monoxide as a by-product in the reformed gas. The carbon monoxide gives rise to deterioration of an anode catalyst of the fuel cell, which leads to reduction of electricity generation output. For reduction of the carbon monoxide content, the CO-shifting part 33 and the CO-removal part 35 disposed downstream of the reforming part 43 may be provided and used.

The CO-shifting part 33 is linked with the reforming part 43 via a flow line or any other appropriate means. The CO-shifting part 33 receives the reformed gas from the reforming part 43 and brings about a shift reaction of carbon monoxide contained in the reformed gas with water molecule to generate carbon dioxide and hydrogen. Thereby, the carbon monoxide content is decreased and the hydrogen content is increased as compared with the reformed gas. The CO-shifting part 33 is provided with internal passages therein for transferring the reformed gas and a shift catalyst is supported on inner surfaces of the internal passages so as to be exposed to the reformed gas flowing therethrough. A temperature of the CO-shifting part 33 is preferably controlled to be from 200 to 300 degrees C. for effectively bringing about the shift reaction. According to this condition, the carbon monoxide content can be reduced to from 2000 ppm to 1%.

As mentioned above, the product gas of the CO-shifting part 33 still contains from 2000ppm to 1% carbon monoxide, which may lead to reduction of electricity generation output. The CO-removal part 35 further reduces the carbon monoxide content.

The CO-removal part 35 is linked with the CO-shifting part 33 via a flow line or any other appropriate means. The CO-removal part 35 receives the product gas of the CO-shifting part 33 and brings about a methanation reaction of carbon monoxide contained therein. The methanation reaction causes addition of hydrogen to carbon monoxide and thereby carbon monoxide and hydrogen are converted into methane and water. The CO-removal part 35 is provided with internal passages therein for transferring the product gas of the CO-shifting part 33 and a methanation catalyst is supported on inner surface of the internal passages so as to be exposed to the shifted gas flowing therethrough. A temperature of the CO-removal part 35 is preferably controlled to be from 200 to 300 degrees C. for effectively bringing about the methanation reaction. Thereby, the carbon monoxide content can be decreased to 100 ppm or less.

The fuel cell system in accordance with the present embodiment suppresses the heat transmission out of the container 7 and hence has relatively high heat efficiency. This leads to down-sizing of the whole constitution of the fuel cell system and high heat efficiency.

The fuel cell system may be further provided with a heat absorption part 47 through which the air flows and oxygen contained in the air is supplied to the combustion part 5A. The heat transferred through the container 7 toward the opening 15 is partly absorbed by the heat absorption part 47 and used to heat the oxygen before flowing into the combustion part 5A. The heat absorption part 47 improves heat efficiency of the fuel cell system.

Although the invention has been described above by reference to certain embodiments of the invention, the invention is not limited to the embodiments described above. Modifications and variations of the embodiments described above will occur to those skilled in the art, in light of the above teachings.

What is claimed is:

1. A fuel reforming system comprising: a container having a double wall and an opening at an end of the double wall, the double wall including an inner wall, an outer wall and a sealed space defined by the inner wall and the outer wall, the sealed space being evacuated;
a fuel supplier supplying a fuel including an organic compound;
a reformer reforming the fuel into a reformed gas including hydrogen, the reformer being enclosed in the container;
a fuel supply path linking the fuel supplier to the reformer; and
a heat absorber being in contact with the inner wall and disposed between the reformer and the opening.

2. The fuel reforming system of claim 1, wherein the heat absorber transfers heat from the inner wall to the fuel supply path to heat the fuel flowing through the fuel supply path.

3. The fuel reforming system of claim 1, wherein the heat absorber comprises a portion of a fluid supply path supplying a fluid to the reformer.

4. The fuel reforming system of claim 1, wherein the heat absorber comprises a portion of the fuel supply path.

5. The fuel reforming system of claim 4, wherein the heat absorber comprises an evaporator evaporating the fuel.

6. The fuel reforming system of claim 1, wherein the heat absorber is disposed so that a ratio of L1/(L1+L2) is 20% or more, where L1 is a distance from the opening to the heat absorber and L2 is a distance from the heat absorber to the reformer.

7. The fuel reforming system of claim 1, wherein the fuel includes dimethyl ether.

8. The fuel reforming system of claim 1, further comprising a heat insulator covering an exterior of the container at least in part.

9. The fuel reforming system of claim 8, wherein the heat absorber transfers heat from the inner wall to the fuel supply path to heat the fuel flowing through the fuel supply path.

10. The fuel reforming system of claim 8, wherein the heat absorber comprises a portion of a fluid supply path supplying a fluid to the reformer.

11. The fuel reforming system of claim 8, wherein the heat absorber comprises a portion of the fuel supply path.

12. The fuel reforming system of claim 11, wherein the heat absorber comprises an evaporator evaporating the fuel.

13. The fuel reforming system of claim 8, wherein the heat absorber is disposed so that a ratio of L1/(L1+L2) is 20% or more, where L1 is a distance from the opening to the heat absorber and L2 is a distance from the heat absorber to the reformer.

14. The fuel reforming system of claim 8, wherein the fuel includes dimethyl ether.

15. A fuel reforming system comprising:
a fuel supplier supplying a fuel including an organic compound;
a reformer reforming the fuel into a reformed gas including hydrogen;
a fuel supply path linking the fuel supplier to the reformer; and
a container to enclose the reformer, the container having a double wall and an opening at an end of the double wall, the double wall including an inner wall, an outer wall and an evacuated space sealed by the inner wall and the outer wall,
wherein at least a part of the fuel supply path is in contact with the inner wall of the container so as to bring about heat absorption from the inner wall to the fuel supply path.

16. The fuel reforming system of claim 15, wherein the part of the fuel supply path to be in contact with the inner wall is disposed between the reformer and the opening.

17. A fuel cell system comprising:
a fuel supplier supplying a fuel including an organic compound;
a reformer reforming the fuel into a reformed gas including hydrogen;
a fuel supply path linking the fuel supplier to the reformer;
a container to enclose the reformer, the container having a double wall and an opening at an end of the double wall, the double wall including an inner wall, an outer wall and an evacuated space sealed by the inner wall and the outer wall,
wherein at least a part of the fuel supply path is in contact with the inner wall of the container so as to bring about heat absorption from the inner wall to the fuel supply path; and
a fuel cell receiving and using the reformed gas to generate electricity.

18. The fuel cell system of claim 17, wherein the part of the fuel supply path to be in contact with the inner wall is disposed between the reformer and the opening.
